(19) United States
(12) Patent Application Publication
(10) Pub. No.: US 2022/0321465 A1
(43) Pub. Date: Oct. 6, 2022

(54) Communication Device

(71) Applicant: Koito Electric Industries, Ltd., Shizuoka (JP)

(72) Inventor: Toshiki Terui, Shizuoka (JP)

(21) Appl. No.: 17/614,492

(22) PCT Filed: May 13, 2020
(86) PCT No.: PCT/JP2020/019073

§ 371 Date: Nov. 26, 2021

(30) Foreign Application Priority Data
May 28, 2019 (JP) 2019-099560

(51) Int. Cl. H04L 45/48

(52) U.S. Cl. CPC H04L 45/48

(57) ABSTRACT

A communication device capable of preventing occurrence of packet loss in a network in which path configuration is determined by RSTP. In a switch, a control unit detects reconnection of a port that is in a discarding state and sends back, to a transmission source, a BPDU that includes a path cost having a value larger than that of a path cost contained in a BPDU that is received after the reconnection from the port at which the reconnection is detected.

### TECHNICAL FIELD

The present invention relates to a communication device capable of changing a path in a network having a single loop structure.

### BACKGROUND ART

To improve network availability, bridges such as L2 (Layer 2) switches are physically connected in a loop and protocols such as STP (Spanning Tree Protocol) and RSTP (Rapid Spanning Tree Protocol) are used. With the STP or RSTP, a part of the loop is logically disconnected to break the loop, and this logically disconnected part is restored when a failure occurs, thereby improving the availability (for example, refer to Patent Documents 1 and 2).

### PRIOR ART DOCUMENTS

### Patent Documents

Patent Document 1: JP 2010-87551 A

Patent Document 2: JP 2011-61474 A

### SUMMARY OF THE INVENTION

### Problem to be solved by the Invention

In the RSTP described above, at the time of the restoration from the failure, packet loss may possibly occur during the path reconfiguration. This will be explained below with reference to the drawings.

In FIG. 7, switches A, B and C are each constituted of an L2 switch, etc., and these switches are connected in a single loop. In FIG. 7, the switch A is a root bridge. Further, in each switch, all ports on which RSTP is valid have the same communication speed (for example, when the communication speed is 100 Mbps, a path cost is 200000; hereinafter, the explanation is provided with this path cost). Further, the switch B is configured to have higher priority than the switch C by means of a bridge ID, and in an initial state a port of the switch C on the switch B side is in a discarding state (blocking state) (in the drawings, shown by an x-mark) so a loop is not created.

In the initial state shown in FIG. 7, a normal communication is being performed. In this state, BPDUs (Bridge Protocol Data Units) are periodically transmitted and received between the respective switches.

When there is a disconnection between the switch A and the switch B due to a failure (FIG. 8), a port of the switch A on the switch B side and a port of the switch B on the switch A side become in a discarding state (blocking state) (in the drawings, shown by the x-marks). Further, the BPDU from the switch B causes the switch C to make the port in the blocking state to transit to a forwarding state (FIG. 8). At this time, since there is a disconnection between the switch A and the switch B, the transmission and reception of the BPDUs are not performed between the switch A and the switch B, and the communication from the switch A to the switch B is performed via the switch C.

Next, when a connection between the switch A and the switch B is restored from the failure (FIG. 9), the transmission and reception of the BPDUs are performed between the switch A and the switch B. The path cost of the BPDU transmitted from the switch B is 400000 which is the sum of the own path cost and the path cost of the switch C (i.e., 200000+200000). On the other hand, the path cost of the BPDU transmitted from the switch A is 0 because the switch A is the root bridge. Thus, the switch A determines that its priority is higher than that of the switch B and makes its port in the blocking state to transit to the forwarding state (FIG. 10).

On the other hand, the switch B also transmits the BPDU to the switch C (FIG. 10). The path cost of this BPDU is 200000 which is the sum of the own path cost and the path cost of the switch A (i.e., 200000+0). The switch C that has received this BPDU makes its port on the switch B side to be in the blocking state and further transmits the BPDU to the switch B (FIG. 11), because, although the path costs are the same, the priority based on the bridge IDs is higher in the switch B.

The switch B that has received the BPDU from the switch C makes its port on the switch A side transited to the forwarding state. In this way, the initial state is restored (FIG. 12).

In the state shown in FIG. 11, the paths from the switch A to the switch B are all intercepted, thus normal packets other than the BPDU cannot be received from the switch A. That is, this may possibly cause packet loss.

In the case of a protocol such as TCP (Transmission Control Protocol) that works to check whether the reception by the receiver side is performed, the packet loss does not occur even when the switch B falls into the above-mentioned state; however, in the case of a protocol such as UDP (User Datagram Protocol) that does not work to check whether the reception by the receiver side is performed, the packet loss occurs, causing data loss and such and affecting the communication.

Therefore, an object of the present invention is to provide a communication device capable of preventing occurrence of packet loss in a network in which path configuration is determined by RSTP.

### Solution to the Problem

In order to solve the above-mentioned problem, the present invention as set forth in claim 1 is a communication device configured to be used as a bridge in a network having a single loop structure, the communication device including a detecting unit configured to detect reconnection of a port that is in a discarding state among ports constituting the single loop structure, and a control unit configured to maintain a path that is connected to the port at which the reconnection is detected by the detecting unit in a non-use state.

The present invention as set forth in claim 2 is the communication device according to claim 1, wherein the control unit is configured to send back, to a transmission source, control information that includes a path cost having a value larger than that of a path cost contained in control information that is received after the reconnection from the port at which the reconnection is detected by the detecting unit.

The present invention as set forth in claim 3 is the communication device according to claim 1 or 2, further including a holding unit configured to hold information of the reconnection detected by the detecting unit.

### Advantageous Effect of the Invention

According to the present invention, since the path that is being connected to the port at which the reconnection is detected is maintained in a non-use state, there is no change in a path from before the reconnection, thereby preventing packet loss.

### BRIEF DESCRIPTION OF THE DRAWINGS

FIG. 1 is a configuration diagram of a network including a communication device according to one embodiment of the present invention;

FIG. 2 is a schematic configuration diagram of the communication device shown in FIG. 1;

FIG. 3 is an (first) illustrative diagram of the network shown in FIG. 1 at the time of restoration from occurrence of a failure;

FIG. 4 is an (second) illustrative diagram of the network shown in FIG. 1 at the time of restoration from occurrence of a failure;

FIG. 5 is a flowchart of an operation of a conventional communication device among the communication devices shown in FIG. 1;

FIG. 6 is a flowchart of an operation of the communication device of the present invention among the communication devices shown in FIG. 1;

FIG. 7 is a configuration diagram of a network including a conventional communication device;

FIG. 8 is an illustrative diagram of the network shown in FIG. 7 at the time of occurrence of a failure;

FIG. 9 is an (first) illustrative diagram of the network shown in FIG. 7 at the time of restoration from occurrence of a failure;

FIG. 10 is an (second) illustrative diagram of the network shown in FIG. 7 at the time of restoration from occurrence of a failure;

FIG. 11 is an (third) illustrative diagram of the network shown in FIG. 7 at the time of restoration from occurrence of a failure; and

FIG. 12 is an (fourth) illustrative diagram of the network shown in FIG. 7 at the time of restoration from occurrence of a failure.

### DESCRIPTION OF EMBODIMENT OF THE INVENTION

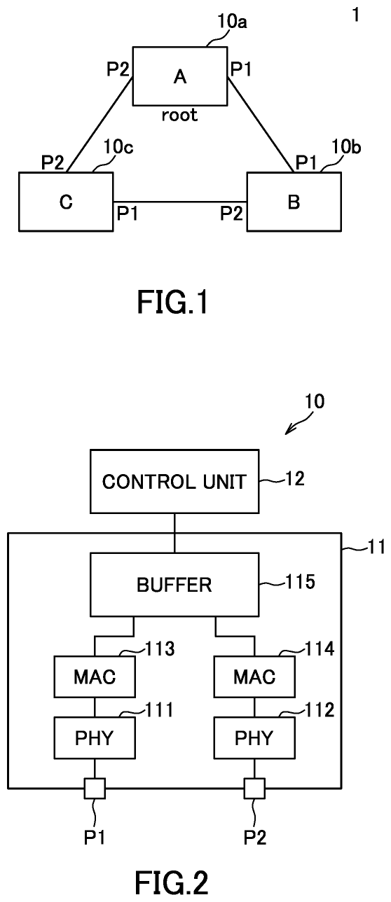

In the following, one embodiment of the present invention will be described with reference to FIG. 1 to FIG. 6. FIG. 1 is a configuration diagram of a network 1 using a communication device according to one embodiment of the present invention. In the network 1, a plurality of switches 10 is connected in a single loop, and in FIG. 1, it is constituted of a switch A 10a, a switch B 10b and a switch C 10c. That is, a port P1 of the switch A 10a is connected to a port P1 of the switch B 10b, a port P2 of the switch B 10b is connected to a port P1 of the switch C 10c, and a port P2 of the switch C 10c is connected to a port P2 of the switch A 10a. The switches 10 can be constituted of bridges such as a L2 switch or a router.

FIG. 2 shows a schematic configuration diagram of the switch 10. FIG. 2 is an example where it is constituted of an L2 switch. The switch 10 includes a switching unit 11 and a control unit 12. Further, the switching unit 11 includes PHY units 111, 112, MAC units 113, 114, and a buffer 115.

The PHY unit 111 is connected to the port P1 and executes processing related to a physical layer of an OSI (Open System Interconnection) reference model. The PHY unit 112 is connected to the port P2 and executes processing related to the physical layer of the OSI reference model.

The MAC unit 113 is connected to the PHY unit 111 and executes processing related to a MAC sublayer of a data link layer of the OSI reference model. The MAC unit 114 is connected to the PHY unit 112 and executes processing related to the MAC sublayer of the data link layer of the OSI reference model.

The buffer 115 exchanges data mutually between the MAC units 113, 114 and the control unit 12 and exchanges data between the MAC units 113, 114.

The control unit 12 executes processing of a layer higher than the data link layer which is processed by the switching unit 11. The control unit 12 is constituted of a microcomputer or the like including a CPU (Central Processing Unit), etc., and executes using a software the RSTP processing described above and processing according to the present invention described later. That is, the present invention can be achieved by changing the software of the control unit 12.

Further, in the example of the network 1, the switch A 10a is a root bridge, and, the switch A 10a and the switch C 10c are switches to which the present invention is applied, and the switch B 10b is a conventional switch. Further, in each switch, all ports on which the RSTP is valid have the same communication speed (for example, when the communication speed is 100 Mbps, the path cost is 200000; hereinafter the explanation is provided with this path cost). In addition, the bridge ID is set such that the switch B 10b has higher priority than the switch C 10c.

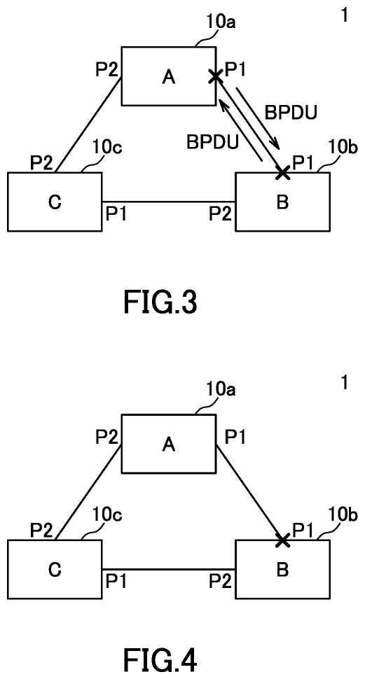

With reference to FIG. 3 and FIG. 4, an operation at the time of reconnection in the network 1 with the above-described configuration and setting will be explained.

First, FIG. 3 is in the same state as FIG. 9 described above. At this time, the transmission and reception of the BPDU are performed between the switch A 10a and the switch B 10b. The path cost of the BPDU transmitted from the switch B 10b is 400000 which is the sum of the own path cost and the path cost of the switch C 10c. In this embodiment, for the switch A 10a, the path cost of the BPDU to be sent back to the switch B 10b is set to 600000 which is a value larger than 400000.

The switch A 10a, since itself is a root bridge, determines that it has higher priority than the switch B 10b, and makes the port P1 in the blocking state to transit to the forwarding state (FIG. 4). In addition, in the switch B 10b, the path cost on the switch A 10a side is larger than the path cost on the switch C 10c side, thus the blocking state is maintained Consequently, a state at the time of the disconnection between the switch A and the switch B is maintained

In this embodiment, the state at the time of disconnection between the switch A and the switch B is maintained, thus, with respect to the switch B 10b, the path from the switch A 10a is not intercepted, and thus no packet loss occurs.

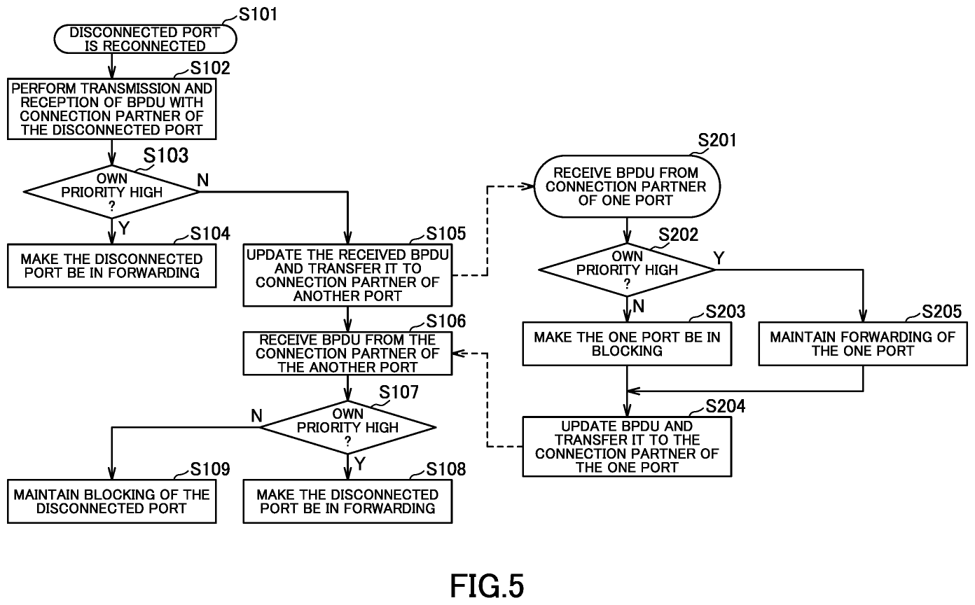

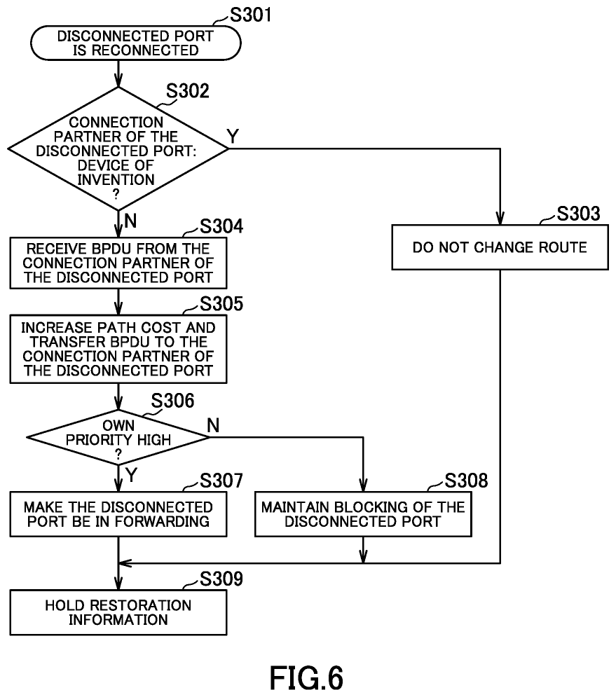

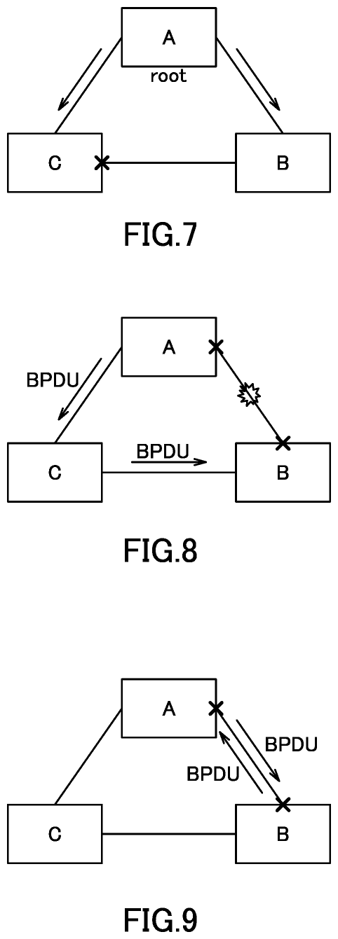

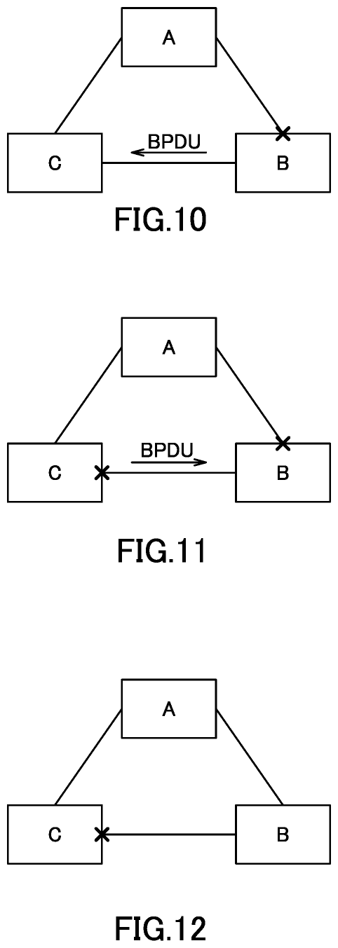

Next, an operation of the switch 10 described above will be explained with reference to FIG. 5 and FIG. 6. Flowcharts shown in FIG. 5 and FIG. 6 are executed mainly by the control unit 12 of the communication device. FIG. 5 illustrates an operation of a conventional communication device (i.e., the switch B 10b). The network 1 shown in FIG. 1 also includes a conventional communication device, and, since the operation of the conventional switch 10 is also associated with the network 1 as described above, the operation of the conventional communication device will be explained first.

The control unit 12, once it detects that the disconnected port is reconnected (step S101), performs the transmission and reception of the BPDU with respect to a connection partner of the disconnected port (step S102). Next, the control unit 12 determines the priority between itself and the connection partner of the disconnected port based on the BPDU received in step S102, and if the own priority is higher (step S103: Y), then makes the disconnected port to transit to the forwarding state (step S104). Herein, the priority is determined based on the path costs, but if the path costs are the same, then the priority is determined by the bridge ID.

On the other hand, as a result of the determination made in step S103, if the own priority is lower (step S103: N), then the control unit 12 updates the path cost, etc. of the received BPDU and transfers it to the connection partner of its another port (step S105). Herein, the another port is a port that is not the disconnected port among the ports constituting the loop.

Next, the control unit 12 receives the BPDU (step S106) from the partner (i.e., the connection partner of the another port) to which the BPDU has been transferred in step S103, and determines the priority between itself and the connection partner of the another port based on the received BPDU, and if the own priority is higher (step S107: Y), then makes the disconnected port to transit to the forwarding state (step S108). On the other hand, as a result of the determination made in step S107, if the own priority is lower (step S107: N), then the control unit 12 maintains the blocking state of the disconnected port (step S109).

The RSTP operation of the conventional switch 10 (the switch B 10b in FIG. 1) including the disconnected port has been described above. Next, an operation of a conventional switch 10 not including the disconnected port will be described.

The control unit 12 receives the BPDU that was transmitted in step S105 via its one port (step S201) and determines the priority between itself and the connection partner of the one port based on said received BPDU, and if the own priority is lower (step S202: N), then makes the one port to transit to the blocking state (step S203). Then, the control unit 12 updates the BPDU and transfers it to the connection partner of the one port (step S204).

On the other hand, as a result of the determination of the priority between itself and the connection partner of the one port made in step S202, if the own priority is higher (step S202: Y), then the control unit 12 maintains the forwarding state of the one port (step S205) and transfers the BPDU to the connection partner of the one port (step S204).

Next, an operation of the switch 10 (i.e., the switch A 10a) applied with the present invention is illustrated in the flowchart of FIG. 6. In the flowchart of FIG. 6, a route passing through step S303 is a route in the case where the connection partner is applied with the present invention. On the other hand, a route passing through steps 5304 to 5308 is a route in the case where the connection partner is not applied with the present invention, in which the connection partner operates according to the flowchart of FIG. 5.

First, the control unit 12, once it detects that the disconnected port is reconnected (step S301), determines whether the connection partner of the disconnected port is the switch 10 applied with the present invention (step S302). This determination of whether the connection partner of the disconnected port is the switch 10 applied with the present invention is made by, for example, setting a value of the upper 3 bytes of a transmission source MAC address of the BPDU to be a specific value for the one applied with the present invention. In other words, the identification can be made in advance from the information contained during the transmission and reception the BPDU prior to the occurrence of a failure and such. That is, the control unit 12 functions as a detecting unit that detects the reconnection of the port that is in the discarding state.

As a result of the determination made in step S302, if the connection partner of the disconnected port is the one applied with the present invention (step S302: Y), the control unit 12 does not change the route (path) (step S303), and the process proceeds to step S309 described later. The expression that the route is not changed in step S303 means that, respective ones maintain the current state of the port (blocking state) so that the route change does not occur. Since the respective communication partners in this step are the ones applied with the present invention, respective ones performing the control so as not to change the route (to maintain this path in a non-use state) at the time of the reconnection in order not to cause packet loss will suffice.

On the other hand, as a result of the determination made in step S302, if the connection partner of the disconnected port is not the one applied with the present invention (step S302: N), then the control unit 12 receives the BPDU from the connection partner of the disconnected port (step S304), increases (raises) the path cost and transfers (sends back) the BPDU to the connection partner of the disconnected port (step S305). The increased value of the path cost is configured to be 600000 in the above example; however, other values may be used as long as the value is larger than the path cost received from the connection partner. That is, the control unit 12 functions as a control unit that is configured to send back, to a transmission source, the control information containing the path cost having a value larger than the path cost contained in the BPDU (i.e., the control information) received after the reconnection from the port where the reconnection is detected by the detecting unit.

Next, the control unit 12 determines the priority between itself and the connection partner of the disconnected port, and if the own priority is higher (step S306: Y), then makes the disconnected port to transit to the forwarding state (step S307). As a result of the determination made in step S306, if the own priority is lower (step S306: N), then the control unit 12 maintains the blocking state of the disconnected port (step S308).

Then, the control unit 12 holds that the disconnected port is reconnected (i.e., holds restoration information) (step S309). This information is held in order to allow that, for example, when a failure occurs in a path different from the path in which a failure had occurred this time, the path which has been restored from this failure that had occurred this time can be used promptly. That is, the control unit 12 functions as a holding unit that holds the information regarding the reconnection detected by the detecting unit.

According to this embodiment, in the switch 10, the control unit 12 detects the reconnection of the port that is in the discarding state and sends back to the transmission source the BPDU containing the path cost having a larger value than the path cost contained in the BPDU received after the reconnection from the port where the reconnection is detected. In this manner, since it is configured to send back the value larger than the path cost received from the port where the reconnection is detected, it is possible to continue the discarding state by the operation of the RSTP even if the connection partner is not applied with the present invention. Thus, since a path is not changed from before the reconnection, it is possible to prevent packet loss.

Further, since the RSTP standard can be used, the combination with a communication device not applied with the present invention is made possible.

Further, since the path is not changed, the transmission and reception of the BPDU are reduced, thereby reducing an occupation time by the BPDU.

Further, since the route is not changed when the connection partner is the one applied with the present invention, the route can be maintained in the non-use state. Thus, since the path is not changed from before the reconnection, it is possible to prevent packet loss.

Further, since the control unit 12 is configured to hold the information regarding the reconnection that has been detected, it can restore when the failure occurs on another path.

The embodiment described above has been explained with the network with three devices; however, it is not limited to the three devices and there may be more than four devices. In this case, a single loop is formed in which the communication device applied with the present invention is provided for every at least one device. Further, the number of the ports included in the communication device is not limited to two, it may be three or more.

The present invention is not limited to the embodiments described above. That is, a person skilled in the art can make and implement various modifications based on conventionally known knowledges without departing from a gist of the present invention. Such modifications of course fall within the scope of the present invention as long as they include the configuration of the communication device the present invention.

### LIST OF REFERENCE SIGNS

1 network
10 communication device
11 switching unit
12 control unit (detecting unit, control unit, holding unit)

1. A communication device configured to be used as a bridge in a network having a single loop structure, the communication device comprising:
a detecting unit configured to detect reconnection of a port that is in a discarding state among ports constituting the single loop structure; and
a control unit configured to maintain a path that is connected to the port at which the reconnection is detected by the detecting unit in a non-use state.

2. The communication device according to claim 1, wherein
the control unit is configured to send back, to a transmission source, control information that includes a path cost having a value larger than that of a path cost contained in control information that is received after the reconnection from the port at which the reconnection is detected by the detecting unit.

3. The communication device according to claim 1, further comprising a holding unit configured to hold information of the reconnection detected by the detecting unit.
